(19) United States
(12) Patent Application Publication
(10) Pub. No.: US 2001/0027361 A1
(43) Pub. Date: Oct. 4, 2001

(54) Fall-protected autonomous travel system with area markers

(75) Inventor: Hermann-Josef Wiegand, Rasdorf (DE)

Correspondence Address: BAKER & BOTTS, 30 ROCKEFELLER PLAZA, NEW YORK, NY, 10112

(73) Assignee: SIEMENS AG.

(21) Appl. No.: 09/840,514

(22) Filed: Apr. 23, 2001

Related U.S. Application Data
(63) Continuation of application No. PCT/DE99/03263, filed on Oct. 11, 1999.

(30) Foreign Application Priority Data
Oct. 23, 1998 (DE) 29818932.1

(51) Int. Cl. G05D 1/03

(52) U.S. Cl. 701/23; 701/28

(57) ABSTRACT

A fall-protected autonomous travel system with area markers is disclosed. Area markers are arranged in the travel area of a mobile unit. The mobile unit contains a spatial scanning device with a sensing range in which the travel area of the mobile unit is scanned in the direction of travel of the mobile unit and area marks located therein are sensed. A program-controlled control device brings the mobile unit to a stop if the spatial scanning device does not sense an area marker located in a first safety sub-range of the sensing area.

### SPECIFICATION

1. Field of the Invention

The present invention relates generally to an autonomous travel system which contains self-propelling mobile units. In particular, the invention relates to the protection of the self-propelled mobile units.

2. Background of the Invention

An autonomous travel system can be used, for example, in the form of a driver-less travel system for a wide variety of tasks. An example of such a task is the transportation of a cleaning device. Such travel systems are also referred to as autonomous cleaning robots.

Prior travel systems have contactless guides which are placed into the floor of the respective travel area, for example in an industrial hall. These contactless guides are used as a type of electronic rail or track, for example on a magnetic basis, for self-propelling the mobile units of the travel system.

In other prior travel systems, the self-propelling mobile units, which may also be referred to as mobile robots, move in an assigned travel area in a quasi-autonomous fashion under the control of a control device which is generally program-controlled. The control device scans a sensing range located at least in the direction of travel in front of a mobile unit using a contactless spatial scanning device. This may be a pulse laser scanner or an ultrasonic sensor scanner. The control device executes a navigation program which, for example in the case of an autonomous cleaning robot, has the function of moving the mobile unit with the most uniform possible coverage over the entire travel area so that the cleaning device which it carries can carry out the cleaning task.

In addition to the navigation program, the program-controlled control device generally also carries out a collision program which prevents a collision between a mobile unit and objects which are detected in the sensing range. In the case of moveable objects, for example persons, in order to avoid collisions the collision program can temporarily bring the mobile unit to a stop until the movable object has left the sensing range. In the case of fixed objects, such as immovable items, and parts of buildings, detours are made under certain circumstances.

A further safety function which may also possibly be required by public supervisory authorities for autonomous travel is that the autonomous travel system be protected under all circumstances against falling. The risk of falling generally occurs only if, for example, due to an error or an irregularity in the execution of the normal navigation program a mobile unit moves into at a position which is unforeseen.

In order to protect against falling, the travel system can have additional structural measures for physically delimiting the assigned travel area, for example grills and barriers. However, such mechanical boundaries are not only costly but, for practical reasons, in many cases cannot be installed at areas where falls can occur, for example staircases, ramps, railroad platforms, etc.

GB-A-2 143 969 discloses a vehicle guiding system which detects markers that are mounted along the route and are provided with a bar code. The vehicle guiding system calculates the necessary course corrections from the information acquired and controls the vehicle accordingly.

EP-A-0 278 853 describes how an autonomous vehicle can be brought to a stop if magnetic markers, mounted along the track and used for guiding the vehicle, can no longer be sensed.

There exists an need for a more efficient and less costly autonomous travel system which protects the mobile units of the autonomous travel system against falling.

### SUMMARY OF THE INVENTION

The present invention provides a system and method for protecting the mobile units of an autonomous travel system against falling. The fall-protected autonomous travel system of the present invention has at least one mobile unit equipped with at least one control device and a contactless spatial scanning device in such a way that it is possible to protect the mobile unit against falling with minimum additional expenditure.

The fall-protected autonomous travel system according to the present invention contains area markers which are spatially distributed in the travel area. In addition, at least one self-propelling mobile unit of the travel system contains a contactless spatial scanning device with a sensing range in which the spatial scanning device scans at least the travel area located in front of the mobile unit in the mobile unit's direction of travel and senses at least the area markers located therein. Furthermore, the self-propelling mobile unit of the travel system contains a program-controlled control device which is connected to the spatial scanning device and brings the mobile unit to a stop if the spatial scanning device no longer senses an area marker which is located in a first safety sub-range of the sensing range.

The system according to the present invention is based on a minimum safety criterion to protect the mobile unit against falling. The minimum safety criterion requires that an area marker located within the first safety sub-range must be detectable by the control device. If this condition is fulfilled, the mobile unit can be moved unimpeded by the control device in accordance with the navigation strategy depending, in particular, on the type of mobile unit. The system according to the present invention can consequently be compared for illustrative purposes with a virtual optical line which does not become active until the mobile unit has reached the virtual limits determined thereby. The protection against falling according to the present invention thus can be used without restriction in an additive fashion along with further navigation and safety programs which are generally already provided and act on the control device.

Such an embodiment has the further advantage that, in order to achieve the additional function of protecting against falling in existing self-propelling mobile units, it is not necessary to undertake any external structural changes. Instead, the function of the protection against falling can be implemented by the control device adapting the system and method of the present invention. These adaptations may be carried out by loading program components.

It is also particularly advantageous that the protection against falling is achieved by defining an additional, appropriately configured safety sub-range in the sensing range of the spatial scanning device which is generally provided in any case for purposes of normal navigation and/or avoidance of collisions and is appropriately evaluated by the program-controlled control device. The program of the control device evaluates this specific segment of the sensing range separately with the aim of protecting the mobile unit against falling.

A further advantage of the present invention is that the area markers, which are spatially distributed in the travel area, do not constitute any artificial obstacles, in particular for persons. Instead, they can be mounted, for example, on parts of buildings such as walls, columns, ceilings and the like without adversely affecting existing spatial structures and movement structures. Due to the length of the sensing range and of the safety sub-range located in it, the area markers do not need to be mounted in the direct spatial vicinity of a location where the mobile unit could fall. Instead, they can be removed to a distance up to a maximum length of the safety sub-range, i.e. the length of the virtual optical line of the system. For example, if the location at which falling is possible is a resting place on a flight of stairs, its accessibility for persons is not adversely affected by area markers of the travel system according with the present invention.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of a plan view of a mobile unit which is guided in a fall-protected fashion on a travel area which has an area where there is a possibility of a mobile unit of falling in accordance with the present invention.

### DETAILED DESCRIPTION OF THE INVENTION

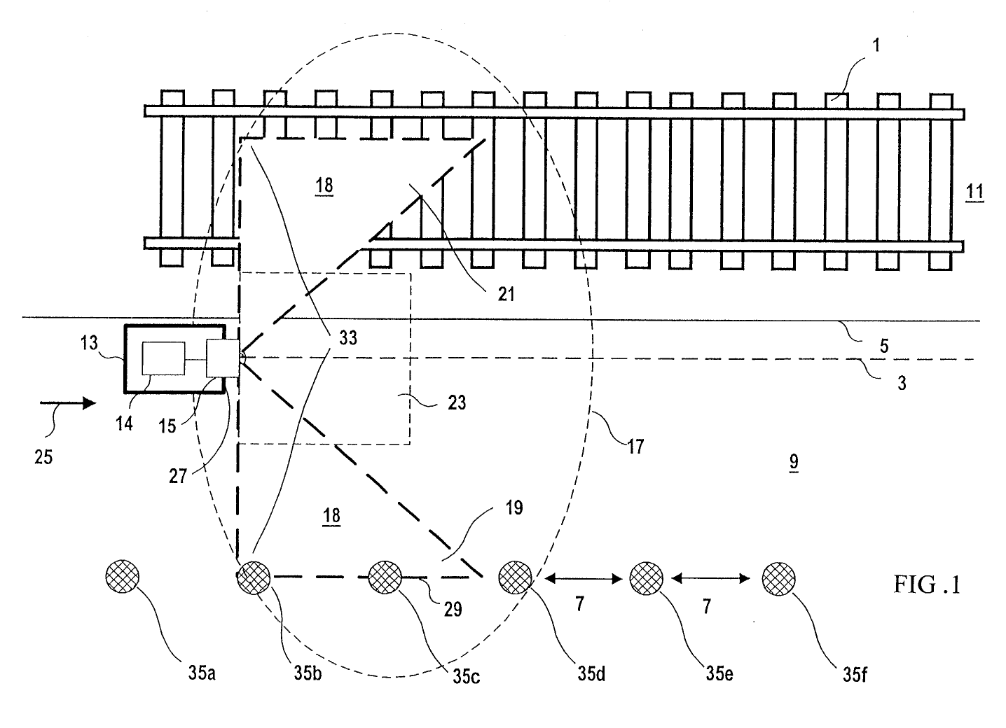

Now referring to the drawing, FIG. 1 illustrates a plan view of a mobile unit 13 in accordance with the present invention which is guided in a fall-protected fashion on a travel area 9 which has an area where there is a possibility of falling. In this exemplary embodiment, a railroad platform forms a raised travel level for a self-propelling mobile unit 13 and is separated by a railroad platform edge 5 from a lowered falling level 11 on which a track system 1 is installed. The railroad platform edge 5 constitutes an area where it is possible for mobile unit 13 to fall. The autonomous travel system according to the present invention ensures that the self-propelling mobile unit 13 does not under any circumstances move over the railroad platform edge 5. As shown in FIG. 1, the self-propelling mobile unit 13 is bounded by line 3 which is illustrated by broken lines and constitutes the center of the track of the mobile unit 13.

Five area markers 35a to 35f are spatially distributed in the travel area 9. Of course, other area markers not shown in the FIG. 1, which may be spatially distributed in the form of a closed ring, may also be provided. In an exemplary embodiment, the guide markers 35a to 35f are arranged in a linear shape parallel to the linear railroad platform edge 5 and are approximately equidistant from each other as marked by a double arrow 7.

The self-propelling mobile unit 13 which, in the example of FIG. 1 moves along the boundary 3 of the travel area 9 in the direction of the arrow 25, contains a contactless spatial scanning device 15 with a sensing range 17. The spatial scanning device 15, preferably a pulse laser scanner, is mounted at the head end 27 of the mobile unit 13 and is connected via a data bus to a control device 14. The sensing range 17 has an oval cross section in this exemplary embodiment. The portion of the travel area 9 which is located at least in front of the mobile unit 13 in the direction 25 of travel in the sensing area 17 is scanned by the spatial scanning device 15 and senses at least a portion of the area markers, i.e. 35b, 35c, 35d area markers located therein.

In accordance with this exemplary embodiment of the present invention, only a part of the sensing range 17 is evaluated by the program-controlled control device 14 in mobile unit 13 for the purpose of protecting the mobile unit 13 against falling. The sensing range 17 contains a first safety sub-range 18. The first safety sub-range 18 advantageously has in each case a right-hand sensing lobe 19 and a left-hand sensing lobe 21 which are directed away from the direction 25 of travel of the mobile unit 13 and are approximately on each side of boundary 3. The maximum length of the two sensing lobes 19 and 21 transversely with respect to the direction 25 of travel is indicated with the reference number 33, and the maximum length of each sensing lobe in the direction of travel is indicated with the reference number 29.

In accordance with the present invention, the mobile unit 13 is brought to a stop by the control device 14 if the spatial scanning device 15 no longer senses an area marker which is present in the first safety sub-range 18 of the sensing range 17. When at least one of the area markers 35a to 35f is not sensed, the mobile unit 13 is advantageously ultimately brought to a forced stop so that the mobile unit cannot be reactivated until, for example, an intervention or a check by an operator.

The maximum extents of the first safety sub-range 18, in particular in the direction 25 of travel, determine the length of the “optical line” of the travel system within the framework of the protection against falling. The distance 7 between adjacent area markers is advantageously smaller than the maximum extent 29 of the first safety sub-range 18 in the direction 25 of travel of the mobile unit 13. In FIG. 1, the adjacent area markers 35c and 35d are located within this outer edge area of the right-hand sensing lobe 19 and are detected by the spatial scanning device 15 and control device 14. In a comparable way, at least two adjacent area markers could also be detected at the rear edge area in the right-hand or left-hand sensing lobe 19 and 21.

According to a further embodiment, the fall-protected autonomous travel system advantageously has carriers for holding area markers which are configured and/or mounted in such a way that an area marker can be detected by the sensing range 17 of the mobile unit 13 from virtually any spatial direction. Such carriers are preferably column-shaped or hemispherical and are mounted on ceilings or supporting parts of buildings.

The area markers can be, for example, in the form of a foil which is placed on the outside of a carrier. In addition, the surfaces of area markers may be shaped in such a way that they can be detected by the spatial screening device 15, for example a pulse laser scanner, and the control device 14 of a mobile unit 13, not only as markers in general but also specifically as area markers which serve to protect against falling. As a result, these area markers can be automatically distinguished by the travel system from other markers which are arranged in the travel area for some other purpose which does not serve to protect against falling.

As already stated above, other segments may also be defined in the sensing range 17 of the spatial scanning device 15 and evaluated by the control device 14 for other purposes, for example for the avoidance of collisions. In the exemplary embodiment of FIG. 1, the sensing range 17 contains a second safety sub-range 23 located approximately directly in the direction 25 of travel of the mobile unit 13. The mobile unit 13 is temporarily brought to a forced stop here by the control device 14 if the spatial scanning device 15 senses a body located in the second safety sub-range 18. After the body is removed, the mobile unit can begin to move again independently.

The present system and method provide for protecting the mobile units of the autonomous travel system against falling. The fall-protected autonomous travel system protects the mobile unit against falling with a minimum possible additional expenditure.

Although the present invention has been described in detail with reference to specific exemplary embodiments thereof, various modifications, alterations and adaptations may be made by those skilled in the art without departing from the spirit and scope of the invention. It is intended that the invention be limited only by the appended claims.

1. A fall-protected autonomous travel system, said system comprising:
a plurality of area markers, said plurality of area markers being spatially distributed in a travel area;
at least one self-propelling mobile unit, said mobile unit comprising:
a contactless spatial scanning device with a sensing range in which said spatial scanning device scans at least said travel area located in the front of said mobile unit in a direction of travel of said mobile unit and senses at least one of said plurality of area markers located therein; and
a program-controlled control device which is connected to said spatial scanning device and controls said mobile unit by means of navigation and safety programs, wherein a first safety sub-range is within said sensing range and, if said spatial scanning device does not sense at least one of said plurality of area marker in said first safety sub-range, said control device brings said mobile unit to a stop to protect said mobile unit against falling, said navigation and safety programs being used additively to act on said control device.

2. The fall-protected autonomous travel system as claimed in claim 1, wherein said first safety sub-range has a right-hand sensing lobe and a left-hand sensing lobe, said sensing lobes being directed away from said direction of travel of said mobile unit.

3. The fall-protected autonomous travel system as claimed in claim 1, wherein at least two of said plurality of area markers area are arranged adjacent to each other such that a distance between adjacent area markers is less than a maximum length of said first safety sub-range in said direction of travel and said adjacent markers are approximately in said direction of travel of said mobile unit.

4. The fall-protected autonomous travel system as claimed in claim 1 further comprising carriers for holding said plurality of area markers, said carriers being configured such that one of said plurality of area markers can be detected by said sensing range of said mobile unit from virtually any spatial direction.

5. The fall-protected autonomous travel system as claimed in claim 1, wherein said sensing range has a second safety sub-range, said second safety sub-range being approximately directly in said direction of travel of said mobile unit and a said control device temporarily bringing said mobile unit to a forced stop if said spatial scanning device senses a body located in said second safety sub-range.
